(19) United States
(12) Patent Application Publication
(10) Pub. No.: US 2010/0053476 A1
(43) Pub. Date: Mar. 4, 2010

(54) SYSTEMS AND METHODS FOR DESPECKLING A LASER LIGHT SOURCE

(76) Inventor: Brian D. Maxson, Riverside, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/547,030

(22) Filed: Aug. 25, 2009

Related U.S. Application Data
(60) Provisional application No. 61/093,331, filed on Aug. 31, 2008.

(51) Int. Cl. H04N 3/26; G03B 21/28; G02B 27/48

(52) U.S. Cl. 348/745; 353/99; 348/E03.048

(57) ABSTRACT

Systems and methods that facilitate the de-speckling of a laser source in a projection televisions. In a preferred embodiment, laser light from a laser source strikes first and second mirrors on its way to a spatial light modulator and projection optics. Preferably the mirrors are incompletely flat, and preferably move or are caused to rotate. The mirrors preferably deviate from flatness by an amount of at least one or more wavelengths, and rotate at a rate different than the video frame rate and at different rates from one another to ensure that light encountering the deviation of the first mirror strikes the second mirror at a different location than on the first mirror. As the coherent light is reflected by the mirrors the path length it takes continuously changes thereby continuously changing the phase of the light striking the screen causing the bright spots in a speckle pattern to continuously disappear and reappear elsewhere on the screen.

### CROSS-REFERENCE TO RELATED APPLICATION

This application claims priority to provisional application Ser. No. 61/093,331 filed Aug. 31, 2008, which application is fully incorporated herein by reference.

### FIELD

The embodiments described herein relate generally to laser light source based projection television and, more particularly, to systems and methods that facilitate the elimination or reduction of laser light source despeckling on a display screen.

### BACKGROUND INFORMATION

Laser light source based projection televisions (PTVs) have a much larger color gamut than conventional projection televisions enabling images to be displayed using a greater range of colors resulting in images with brilliant colors. However, as with other systems using laser light, laser light source based PTVs can experience the occurrence of speckling as the images are projected on to the screen.

The speckling that happens when an illuminating laser strikes a rough surface of the display screen can distract viewers and interfere with their enjoyment of a video from a laser-illuminated video projector. The speckles occur at points where the coherent light emerging from one point on the screen interferes with light emerging from another nearby point. The bright points in a speckle pattern are a function of the local heights of points on the screen and of the phase of the light waves.

In a video projector, one way to eliminate speckle is to continuously change the path length that the coherent light takes, in effect continuously changing the phase of the light striking the screen. With the path and/or phase of the light striking the screen continuously changing, the bright spots in the speckle pattern disappear and reappear somewhere else continuously. Although the screen is still speckling, the speckle pattern is changing between frames and in the end, the viewer's eye integrates the speckles of individual frames into a continuous level of color.

Thus, systems and methods that eliminate the viewer's recognition or awareness of speckling on the display screen are desirable.

### SUMMARY

The embodiments provided herein are directed to systems and method that eliminate or significantly reduce a viewer's recognition or awareness of screen speckling due to scintillation. In one embodiment, a television includes a video display screen mounted on an enclosure and a laser light source, an image engine, and optics including mirrors and lenses optically coupled to the display screen. Laser light from the laser light source is directed toward first and second mirrors on its way to a spatial light modulator and projection optics. Preferably the first and second mirrors are incompletely flat, and preferably one or both of the first and second mirrors move or are caused to rotate by motors. Alternatively, the first mirror or the second mirror, or both, vibrate or oscillate in the direction the light beam is traveling. Optionally, a collimating lens is included to correct the deviations in beam directions introduced by the mirrors. The mirrors preferably deviate from flatness by an amount of at least one or more wavelengths, and move, rotate or vibrate at a rate different than the video frame rate and at different rates from one another to ensure that light encountering the deviation of the first mirror strikes the second mirror at a different location than on the first mirror. As the coherent light is reflected by the first and second mirrors the path length or direction it travels or is directed continuously changes which in effect continuously changes the phase of the light striking the screen. As a result, bright spots in the speckle pattern continuously disappear and reappear elsewhere on the screen changing the speckle pattern between frames which allows the viewer's eye to integrate the speckles of individual frames into a continuous level of color.

Advantageously, the second mirror (whether rotating or vibrating) lengthens the interval between times that a particular point would sparkle—if the rotation or vibration rates are chosen as two primes, then that interval becomes the product of the two rates. This may also be useful for applications that require a beam be decohered for a certain interval of time (including video display.)

Other objects, systems, methods, features, and advantages of the invention will be or will become apparent to one with skill in the art upon examination of the following figures and detailed description. It is intended that all such additional systems, methods, features and advantages be included within this description, be within the scope of this invention, and be protected by the accompanying claims. It will be understood that the particular methods and apparatus are shown by way of illustration only and not as limitations. As will be understood by those skilled in the art, the principles and features explained herein may be employed in various and numerous embodiments.

### BRIEF DESCRIPTION OF THE FIGURES

The details of the example embodiments, including fabrication, structure and operation, may be gleaned in part by study of the accompanying figures, in which like reference numerals refer to like parts. The components in the figures are not necessarily to scale, emphasis instead being placed upon illustrating the principles of the example embodiments. Moreover, all illustrations are intended to convey concepts, where relative sizes, shapes and other detailed attributes may be illustrated schematically rather than literally or precisely.

FIG. 1 is a side view schematic of a projection television (PTV) with a laser light source.

FIG. 2 is a perspective view schematic of a despeckling mirror system incorporated in the PTV shown in FIG. 1.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

Each of the additional features and teachings disclosed below can be utilized separately or in conjunction with other features and teachings to produce systems and methods that eliminate or significantly reduce a viewer's recognition or awareness of screen speckling due to scintillation. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

Example embodiments provided herein are described in relation to a projection television for exemplary purposes only. One of ordinary skill in the arts would readily recognize that the embodiments could be utilized in other projection systems utilizing a laser light source to illuminate an image on a display screen.

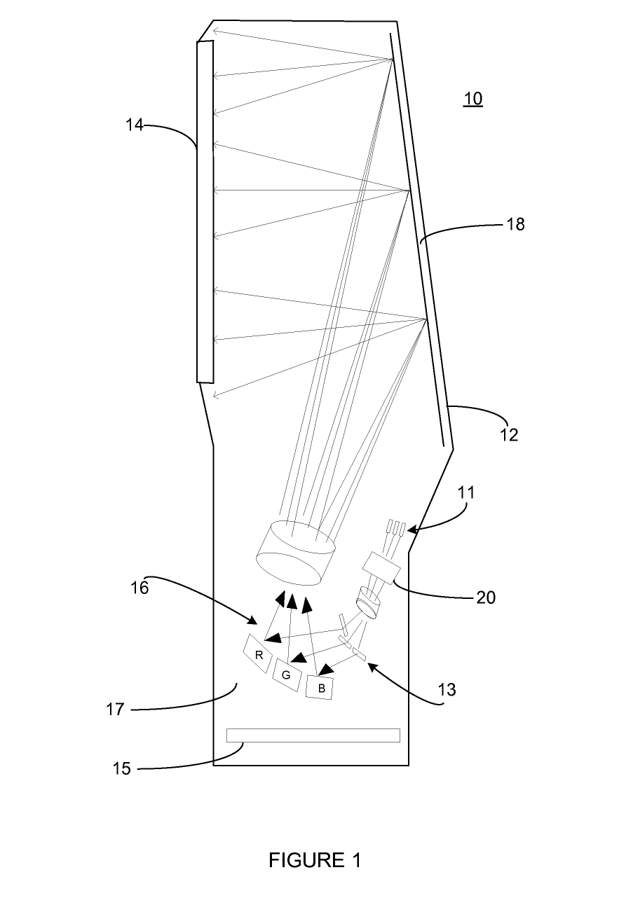

Turning in detail to the figures, FIG. 1 depicts a schematic of a projection television (PTV) 10 having a laser light source. The PTV 10 comprises a cabinet or enclosure 12, an image projection engine or system 13, e.g., a DLP, LCD or LCOS based projection engine or the like, optics such as mirrors 16 coupled to the image engine 13, a laser light source 11 coupled to the image engine 13, a projection screen assembly 14 attached to the front of the cabinet 12, and a mirror 18 mounted in the interior 17 of the cabinet 12 and optically coupled to the projection screen assembly 14 and the image projection engine 13 and optics 16. Also mounted in the interior 17 of the cabinet 12 is a chassis 15 comprising logic circuits and other electronic components.

As noted above, speckling will occur when light illuminating from laser light source 11 strikes the rough surface of the lenticular screen of the display screen assembly 14. This speckling can distract viewers and interfere with their enjoyment of a video. In order to eliminate the appearance to a viewer of speckles on the screen, the speckles should not appear in the same place on the screen 14 for a long enough time for the viewer to notice them. The position of the speckles should change preferably at least every frame of the projection video. In addition, speckled portions of the video image versus non-speckled portions of the video image should not appear in the same place in every frame, nor creep steadily through the video image over time. In order to accomplish this, the PTV shown in FIG. 1 is preferably equipped with a laser light despecking mirror system interposing the laser light source 11 and the image engine 13. The image engine 13 preferably includes a spatial light modulator.

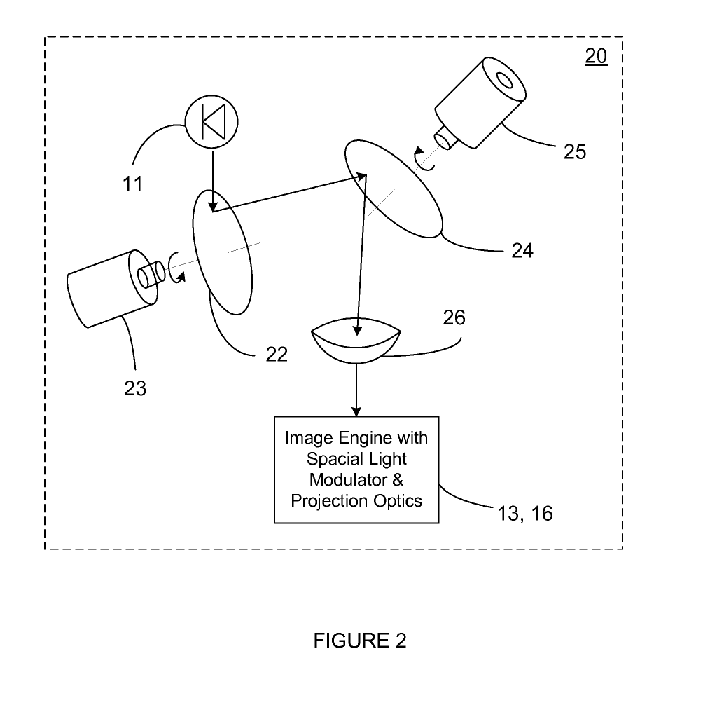

Turning to FIG. 2, as depicted, the despecking mirror system 20 preferably comprises first and second mirrors 22 and 24 that include incompletely flat reflective surfaces. The first and second mirrors 22 and 24 are coupled to the rotatable shafts of first and second motors 23 and 25. Optionally, a collimating lens 26 is included to correct the deviations in beam directions introduced by the first and second mirrors 22 and 24. The reflective surfaces of the first and second mirrors 22 and 24 preferably deviate from flatness by an amount of at least one or more wavelengths.

In operation, laser light emanating from the laser light source 11 is directed toward the first and second mirrors 22 and 24 on its way to the spatial light modulator of the image engine 13 and the projection optics 16. Preferably, one or both of the first and second mirrors 22 and 24 move or are caused to rotate by the motors 23 and 25. The collimating lens 26, if included, corrects the deviations in beam directions introduced by the first and second mirrors 22 and 24. As noted above, the reflective surfaces of the mirrors 22 and 24 preferably deviate from flatness by an amount of at least one or more wavelengths. The first and second mirrors 22 and 24 preferably rotate at a rate different than the video frame rate and at different rates from one another to ensure that light encountering the deviation of the first mirror 22 strikes the second mirror 24 at a different location than on the first mirror 22. As the coherent light is reflected by the first and second mirrors 22 and 24, the path length or direction it travels or is directed continuously changes which in effect continuously changes the phase of the light striking the screen 14. As a result, bright spots in the speckle pattern continuously disappear and reappear elsewhere on the screen 14. Changing the speckle pattern between frames allows the viewer's eyes to integrate the speckles of individual frames into a continuous level of color and, thus, give the appearance to the viewer of a despeckled screen.

Alternatively, one or both of the first and second mirrors 22 and 24 vibrate oscillate in the direction of the light beam.

Advantageously, the second mirror (whether rotating or vibrating) lengthens the interval between times that a particular point would sparkle—if the rotation or vibration rates are chosen as two primes, then that interval becomes the product of the two rates. This may also be useful for applications that require a beam be decohered for a certain interval of time (including video display.)

In the foregoing specification, specific example embodiments have been described. It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

What is claimed is:

1. A projection television comprising
an enclosure,
a projection screen assembly coupled to the enclosure,
an image projection engine optically coupled to the screen,
a laser light source optically coupled to the image engine, and
a despecking mirror system optically coupled to and interposing the laser light source and the image engine, the mirror system comprising first and second mirrors and wherein the first mirror comprises a non-flat reflective surface and is movable relative to the second mirror.

2. The projection television of claim 1 wherein the first mirror is rotable about its axis.

3. The projection television of claim 2 wherein the second mirror is rotable about its axis.

4. The projection television of claim 3 wherein the second mirror comprises a non-flat reflective surface.

5. The projection television of claim 1 wherein the reflective surface of the first mirror deviates from flatness by one or more wavelengths of the light from the laser light source.

6. The projection television of claim 5 wherein the reflective surfaces of the first and second mirror deviate from flatness by one or more wavelengths of the light from the laser light source.

7. The projection television of claim 1 wherein the first mirror vibrates in the direction of the light beam.

8. The projection television of claim 1 wherein the first and second mirrors vibrate in the direction of the light beam.

9. The projection television of claim 3 further comprising first and second motors coupled to the first and second mirrors causing the mirrors to rotate.

10. The projection television of claim 1 further comprising a collimating lens interposing the despecking mirror system and the image engine.

11. A process of projecting a video image on a screen comprising the steps of
directing laser light emanating from a laser light source toward first and second mirrors, wherein at least on of the first and second mirrors comprises a non-flat reflective surface,
moving the at least one of the first and second mirrors with a non-flat reflective surface relative to the other mirror,
reflecting laser light off the second mirror toward a spatial light modulator of the image engine.

12. The process of claim 11 wherein the step of moving the at least one of the first and second mirrors includes rotating the at least one of the first and second mirrors relative to the other mirror.

13. The process of claim 12 further comprising the step of rotating the other mirror relative to the at least one of the first and second mirrors relative.

14. The process of claim 11 wherein the step of moving the at least one of the first and second mirrors includes vibrating the at least one of the first and second mirrors in the direction of the light beam.

15. The process of claim 14 further comprising the step of vibrating the other mirror in the direction of the light beam.

16. The process of claim 11 wherein the other mirror comprises a non-flat reflective surface.

17. The process of claim 11 wherein the reflective surface of the at least one of the first and second mirrors deviates from flatness by one or more wavelengths of the light from the laser light source.

18. The process of claim 16 wherein the reflective surfaces of the first and second mirror deviate from flatness by one or more wavelengths of the light from the laser light source.
